(19) United States
(12) Patent Application Publication
(10) Pub. No.: US 2014/0108963 A1
(43) Pub. Date: Apr. 17, 2014

(54) SYSTEM AND METHOD FOR MANAGING TAGGED IMAGES

(71) Applicant: Ponga Tools, Inc., Berkeley, CA (US)

(72) Inventors: Alexander Fairweather Black, Berkeley, CA (US); Barbara Faison Tien, Berkeley, CA (US); Hans Eugene Friedrich, Los Angeles, CA (US); Stephen Daniel Judkins, Portland, CA (US); Toby Mathew Keller, Mission Viejo, CA (US)

(73) Assignee: Ponga Tools, Inc., Berkeley, CA (US)

(21) Appl. No.: 14/056,786

(22) Filed: Oct. 17, 2013

Related U.S. Application Data
(60) Provisional application No. 61/715,194, filed on Oct. 17, 2012.

(51) Int. Cl. G06F 3/0484

(52) U.S. Cl. CPC G06F 3/04845
USPC 715/753

(57) ABSTRACT

A system and method for tagging media can include obtaining a media object and presenting the media within a media tagging interface; in the media tagging interface, obtaining selection of a region of the presented media to create a first media tag; obtaining user selection of at least a first application instance to assign to the first media tag; collecting content of the first application instance; rendering the tagged media with an indicator in the region of the first media tag; and on selection of the indicator in the rendered tagged media, activating a user interface of the first application instance with the collected content.

### CROSS-REFERENCE TO RELATED APPLICATIONS

This application claims the benefit of U.S. Provisional Application No. 61/715,194, filed 17 Oct. 2012, and titled “SYSTEM AND METHOD FOR MANAGING TAGGED IMAGES” which is incorporated in its entirety by this reference.

### TECHNICAL FIELD

This invention relates generally to the image interface field, and more specifically to a new and useful system and method for managing tagged images in the image interface field.

### BACKGROUND

With more and more devices including a camera, people are taking more pictures than ever before. Despite the ease of taking a picture, using the picture to convey meaningful information is challenging. It often requires writing a description, which in some situations can be slow and difficult. If there is considerable information to convey about an image it only becomes more challenging to convey this extra information. Thus, there is a need in the image interface field to create a new and useful system and method for managing tagged images. This invention provides such a new and useful system and method.

### BRIEF DESCRIPTION OF THE FIGURES

FIG. 1 is a schematic representation of a system of a preferred embodiment of the invention;

FIG. 2 is a schematic representation of activated application instances of various media tags;

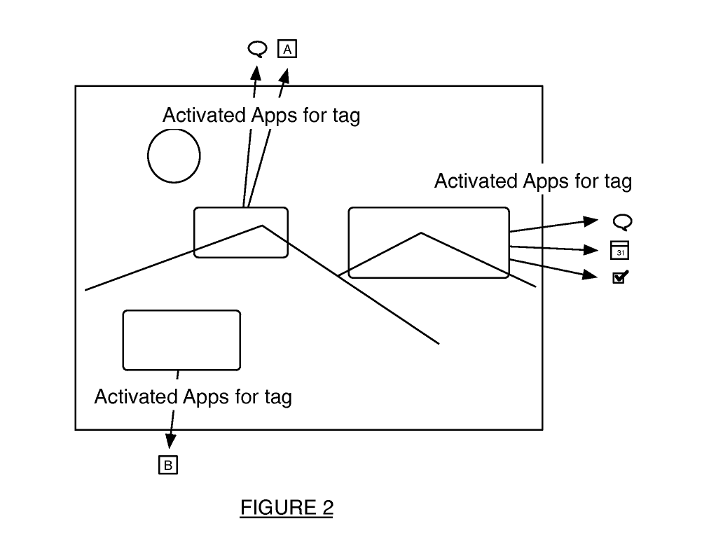

FIG. 3 is a schematic representation of a method of a preferred embodiment of the invention;

FIG. 4 is a communication flow representation of assigning a media tag to a media object;

FIG. 5 is a communication flow representation of sharing a tagged media object;

FIG. 6 is a schematic representation of an exemplary image tagging interface;

FIG. 7 is a schematic representation of an exemplary video tagging interface;

FIG. 8 is a schematic representation of an exemplary three-dimensional model tagging interface;

FIG. 9 is a communication flow representation of adding a new application to use with a media tag;

FIG. 10 is a schematic representation of an exemplary question and answer application;

FIG. 11 is a schematic representation of an exemplary scheduling application;

FIG. 12 is a schematic representation of an exemplary machine vision based application;

FIG. 13 is a schematic representation of an exemplary rendered interface of a calendar application;

FIGS. 14A and 14B are schematic representations of variations of tiling the image of a preferred embodiment;

FIG. 15 is a schematic representation of an exemplary rendered media object with the media tag in a sidebar;

FIG. 16 is a schematic representation of an exemplary rendered media object with the media tag in a popover; and

FIG. 17 is a communication flow representation of providing a media tag API.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Managing Tagged Images

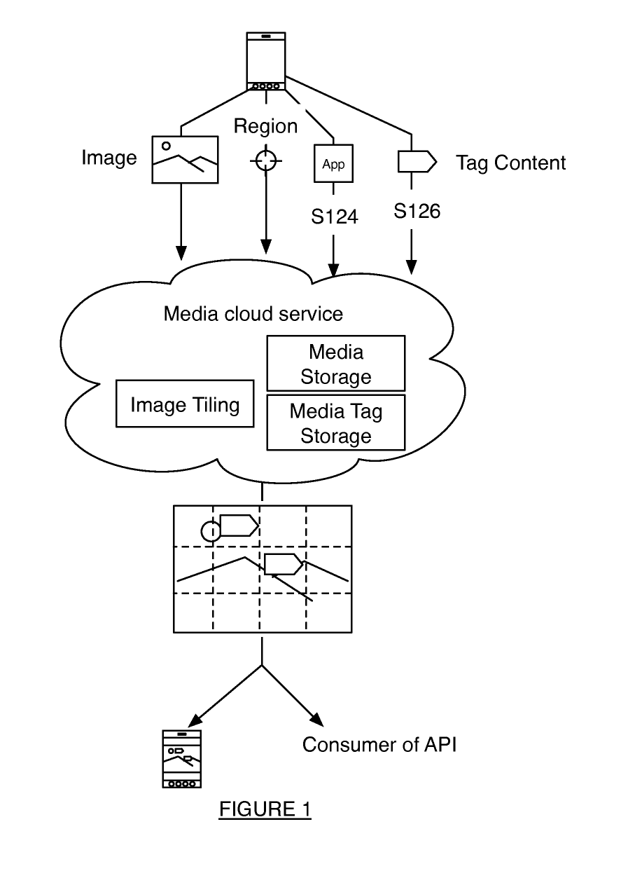

As shown in FIG. 1, a system of a preferred embodiment can include a media tagging platform configured for tagging of media, sharing of tagged media, and integration of internal and external applications with media tags. The media tagging platform is preferably a multitenant platform wherein multiple user accounts can be created and used to create, view, and/or interact with tagged media. The media tagging platform preferably uses a framework with which numerous applications (alternatively described as widgets, plug-ins, applets, services, and the like) can be added and used within the platform for different media tagging scenarios. Such applications can be selectively activated and used within a media object (e.g., an image), a set of media objects, or an account. Such application instances (and their corresponding content/metadata) are preferably attached and associated with individual tags in a media object. The media tagging platform further functions to provide sharing, viewing, and interaction with tagged media objects. The media tagging platform can host and serve the media, media tags, and application instances. The media tagging platform described herein uses image media tagging as a preferred medium but the system can additionally or alternatively be implemented with other suitable forms of media such as video, 3D models, audio, or other suitable media formats.

An image tagging platform of a preferred embodiment can include a media cloud service, a media tagging interface, and an image tiling system. The system functions to create and host images that are tagged with additional content or components. The system is preferably an internet accessible service or platform, but may additionally be configured to work in cooperation with one or more client applications. Users can preferably access the media cloud service from a website, an application, and/or through an application programming interface (API). In an exemplary use-case of the system, a user can use a mobile application with the media tagging interface to capture a photograph, tap or select where the user wants to place a media tag, and then set the content of the media tag. In one variation, the content may be tied to a calendar application and the media tag can serve as an event reminder associated with that region of the image. In another variation, the content can be a link to another tagged image. In another variation, the content can be a text or HTML formatted media added to a comment thread. In yet another variation, the content can be automatically generated from an application using a machine vision process. Additionally, a media tag can have multiple forms of content added through activating multiple applications for a given media tag. The tagged image is preferably communicated from a client application to the media cloud service, where the media object and media tags can then be stored, retrieved, and/or delivered. The system may be used to support any suitable application of image tagging.

The media cloud service of a preferred embodiment is preferably a distributed computing system that hosts and optionally processes the tagged images. The media cloud service preferably includes storage for the images and databases to store parameters of the media tags and images. The system may additionally or alternatively include a client side application that supplements operations of the above components and/or replaces the above components. In one variation, the client side application is an application module operational on a mobile computing device. In another variation, the client side application is a script or application running in a browser. The media cloud service preferably manages the tagged images for a plurality of users. In one variation, the media cloud service may additionally facilitate real-time updates of users collaboratively interacting with image tagging content. The media cloud service can include real-time communication systems to coordinate and synchronize interactions of an image shared with at least two endpoints. The media cloud service or any suitable network accessible resource may be used to coordinate the interactions of one user on the device of at least a second user.

The media cloud service additionally includes an application configuration module, which functions to enable applications to be added to the tagging platform. The media tagging platform, in one implementation, can enable outside developers to build tag applications that can be used with tagged media. For example, an outside developer for a calendar application can create a media tag application enabling integration with the calendar application. In addition, to user accounts which can be used to create tagged media and/or interact with tagged media, the platform can include developer accounts which can manage configuration of third party applications. The third party applications preferably use a media tag protocol to interact with media tags. The application logic of the application in one implementation is a JavaScript application, but the application can be defined in an external web application or using any suitable programming language or tools.

The media cloud service can additionally include a media tag application programming interface (API) service, which functions to enable programmatic interaction with tagged media. The media tag API service preferably creates accessible resources to augment or access information of a media tag. As the system involves the use of tagged media regions, the API preferably enables unique media interaction by third party applications. In one example, the media tag API can be used by an outside application to access and use the various image regions across multiple images in an outside application. In one implementation, the API is a representational state transfer API, but the media tag API can alternatively be a SOAP API or any suitable type of API.

The media tagging interface of a preferred embodiment functions to create, read, update, and delete images and tags. The media tagging interface can include a user interface for user control of tagging and/or a programmatic interface for application control of tagging. In one variation, a user interface may be provided that includes an image capture mechanism, an image viewing interface, and a media tag application interface. The media tagging interface may alternatively be implemented through the media tag API.

The image capture mechanism functions to obtain, retrieve, or receive images for tagging. A user preferably uploads the images through the image capture mechanism, but the image capture mechanism can additionally or alternatively capture the image from an imaging system (e.g., a digital camera). In yet another variation, the image capture mechanism uses existing images from a URI, a media sharing website (e.g., a social network or photo hosting site), or any suitable source. The images are preferably transferred to the image viewing interface.

The image viewing interface functions to explore the image and add or adjust media tags. The image viewing interface displays the image. In one variation, the image is displayed as a tiled image through the image tiling system. The tiling can function to preserve high resolution imagery while enabling efficient viewing of an image. A variety of tag applications can depend on or benefit from a high resolution selection of an image. The image viewing interface can include zoom tools to zoom in and out of the image. A tag creation tool of the image viewing interface can additionally be used to define a region of a new image tag which can then be completed by activating at least one media tag application instance to associate with the media tag. The tag creation tool can additionally be used to select existing tags for content editing, for redefining the region (e.g., size and positioning of the region), and/or deleting the image tag.

The media tag application interface functions to display an interface for interacting with application instance content associated with a media tag. The media tag application interface can additionally include an application selection interface to select one or more applications to associate with the media tag. There can be a plurality of different applications available for a media tag. The applications can be internal applications and/or third party applications. In one variation, a user account preferably adds or installs different applications to the account. An application can alternatively be added to an individual image, an album of images, or any suitable collection of media. Of the set of possible applications available when viewing an image, at least one application instance is activated for a media tag. Activating an application instance describes when content is generated for the media tag that is associated with that application instance. The content can be collected from one or more users or alternatively automatically generated. A media tag can have multiple activated application instances. For example, a media tag can include a comment application instance where a description of the media tag and a discussion can take place, and additionally a scheduling application instance where an event is defined in association with the media tag.

The media tag application interface additionally displays customized interfaces of an application when the application is selected and/or activated for a media tag. The interface can include any suitable user interface elements and is preferably defined or generated by the media tag application logic. In some variations, the media tag application includes at least one element to obtain content from a user. Various form elements can be used to collect content. In other variations, the media tag application can automatically generate content. For example, a machine vision based application used to scan UPC codes may access product information based on media tags that contain a UPC code. The content of an application instance is preferably associated with the media tag. When a tagged image is being used, a similar interface can be used for presenting the content of the media tag. A display interface of the media tag interface can be used when displayed to users without editing capabilities. A media tag interface can alternatively be used to update content through use of the application instance such as by collecting new comments in a comment application. The media tagging interface can execute the media tag application interface within a container. In one variation, the media tag application is an iframe of a URI of the tag application.

The image tiling system of a preferred embodiment functions to process images for better handling by the media cloud service or an application. The image tiling system preferably divides an image into smaller tiles or sub-images. The sub-images are preferably uniformly shaped and sized. The image tiling system may additionally generate tiles for different zoom levels. The image tiling system preferably works in cooperation with the media cloud service to provide better serving of the tagged images to requesting parties. The image tiling system may alternatively be used on a client application to enable better upload of an image to the media cloud service. The tiling system can additionally be adapted for use with video tiling, 3D model tiling, audio modeling, or any suitable medium. Video tiling can include dividing the video into multiple time segments that can be combined to form the whole video. Audio could similarly be segmented into different time segments. Additionally or alternatively, the video can be segmented into spatial sub-regions of the video, wherein the video sub-regions can be combined to form the full image of the video. A 3D model could be divided into different sub-volumes or have its geometry progressively reduced in resolution relative to its size on the display to form a representation of the original, full-resolution 3D model.

### 2. Method for Managing Tagged Images

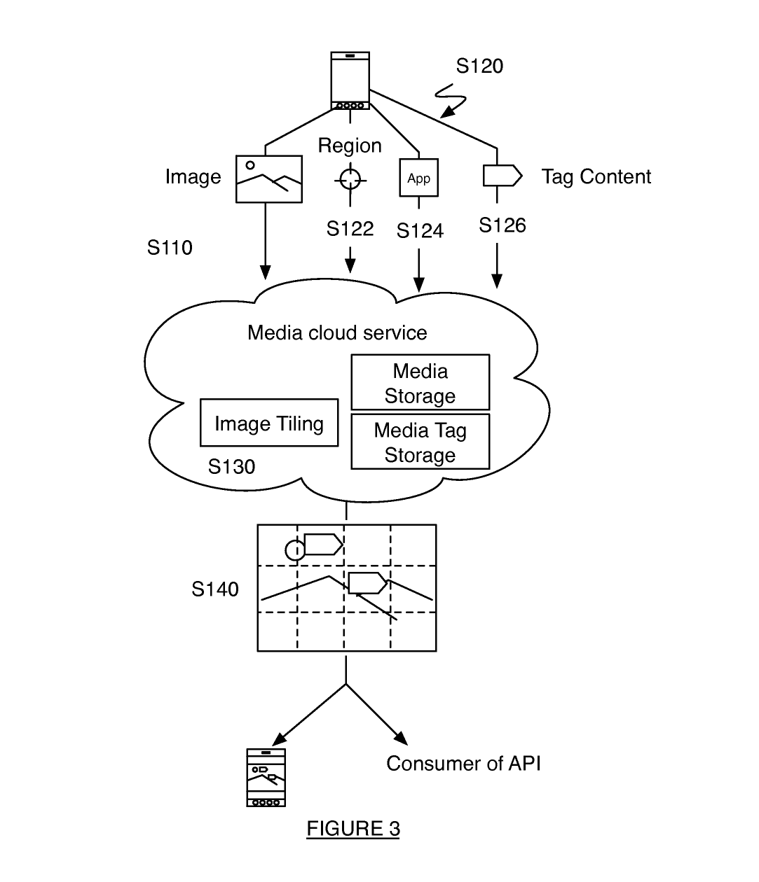

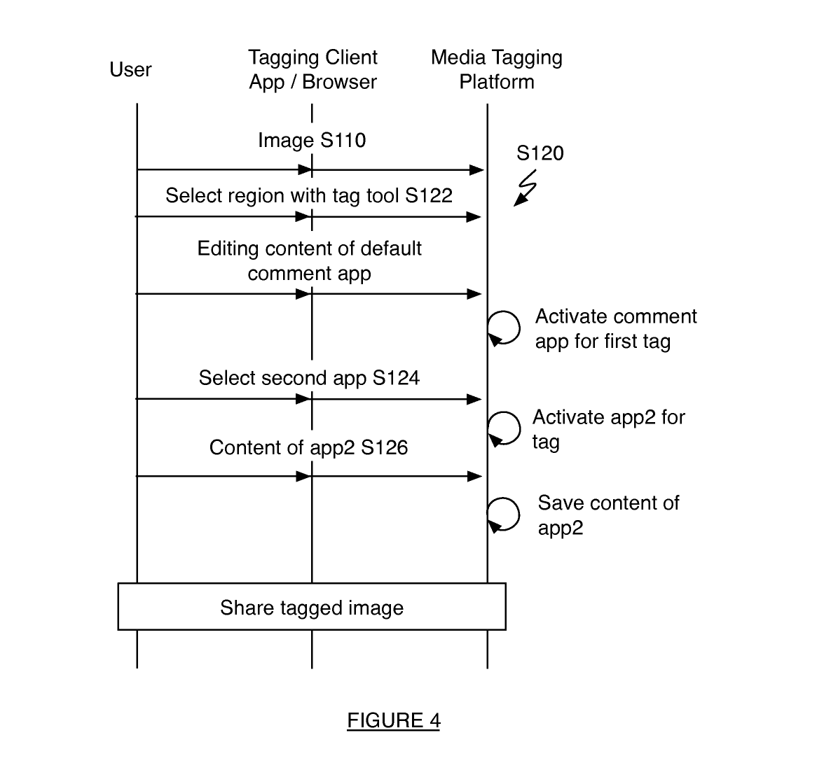

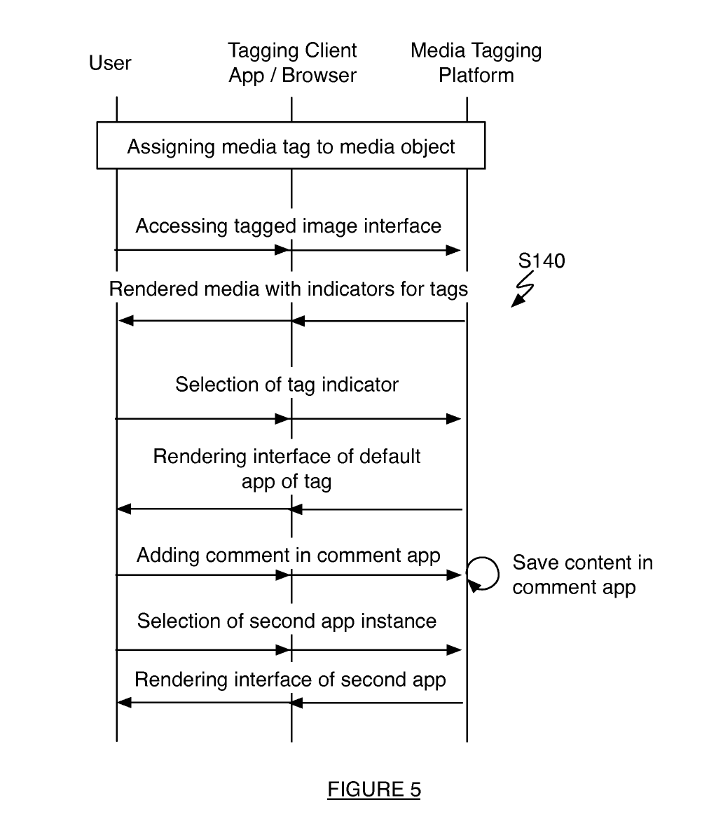

As shown in FIG. 3, a method for managing tagged media of a preferred embodiment can include collecting a media object S110, assigning at least one media tag to a region of the media object S120 that includes selecting the region of the media object S122, activating at least one application instance to be associated with the media tag S124, and collecting content of the media tag with the selected region S126, and rendering the media object with the media tag S140. The method can additionally include tiling the media image S130. The method functions to enable efficient tagging and annotation of media with application content. The method further functions to provide a media tagging platform usable for a wide variety of applications. The applications are preferably implemented to use the regionally defined regions of media tags to facilitate various interactions. The media tag applications preferably promote deeper interaction with the content captured in media. While photographic or graphical images are a preferred media medium, the method is not limited to images and may additionally or alternatively used in tagging videos, 3D models, audio files, multimedia files, or other suitable media mediums. Herein, image media is used as an exemplary medium, but the other forms of media can similarly be used. The method is preferably implemented by a media tagging platform as described above, but may alternatively be implemented by any suitable system. In one variation, a client application in cooperation with a media cloud service preferably implements the method as shown in FIGS. 4 and 5. The method preferably enables a user or client device to generate tags through an interface. An interface facilitating a portion of the method may be a user application interface or an application programming interface (API). With an image tagging API, third party applications or services can preferably leverage the image tagging platform to provide customized tag mediums and varying use-cases of tagged images. For example, a gardening application may enable a user to tag plants with a special garden application that provides plant information. As another example, a calendar application could enable calendar events to be added to an image tag. While the method can enable such rich applications to be embedded into image tagging interactions, a media tagging platform can further enable a full marketplace of different applications that can be used in different combinations with tagged media.

Step S110, which includes collecting a media object, functions to receive a media file to be tagged. As mentioned above, the media object is preferably an image (e.g., a photograph or a graphic) created or sent from a user device. In one exemplary scenario, a user logs in to an account and uploads a new image he would like to tag. In another variation, the user logs in to an account and then authorizes the media tagging platform to access a photo from a social network account or any suitable outside site. The media tagging platform uses an API of the site to retrieve an image. In another variation, the image is collected at the media cloud service through an API. In one exemplary scenario, a developer can set a camera to automatically submit a new image every hour. This could be useful in situations where periodic analysis of a camera image is routinely performed such as in science research, manufacturing, and other scenarios. In another variation, a client application can facilitate the capturing and/or collection of the image on the user device. The image is then preferably communicated from the user device to the media cloud service. The image tiling system may tile the image prior to communicating to the media cloud service. The collected media object is preferably stored in a full resolution such that the detail of the originally collected media object is maintained. The method can use the tiling system to facilitate interacting with full resolution media objects. Alternatively, the media object can be transcoded to satisfy a maximum media resolution requirement. Collection of video, a 3D model or other media mediums can be similarly performed.

Step S120, which includes assigning at least one media tag to a region of the media object, functions to tag a portion of the image. The media tag is preferably supplemental information or mechanisms (an event trigger, view, or link) for a sub-portion of the image. An image may have any suitable number of media tags assigned to it. For example, a photo of a garden can include media tags for each type of plant shown in the image. Additionally, a media tag can selectively have one or more application instances established. An application instance functions to provide content information in association with the media tag. The application is preferably selected from a set of applications. The set of applications can include default internal applications provided by the media tagging platform but can additionally or alternatively include third party applications with a customized content interface and/or interactions. The creation of the media tag is preferably initiated from user input on a user application interface. The user will preferably select a region of the image, create or select content for the media tag, and optionally, confirm or save an automatically generated media tag. Alternatively, an application or device may programmatically create a media tag for an image by using an API to select a region of the image and create or select content for the media tag. Upon assigning the media tag to the image, the image and the media tag are preferably communicated to the media cloud service for storage. Alternatively, the image and media tag may be stored at least temporarily on the device. The image and the one or more media tags may be communicated in one communication or alternatively communicated separately or communicated to the media cloud service in any suitable manner.

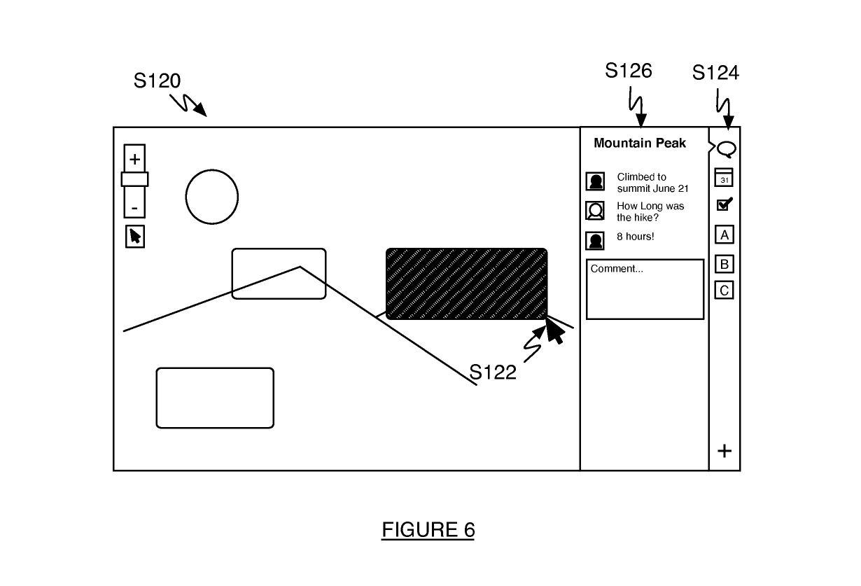

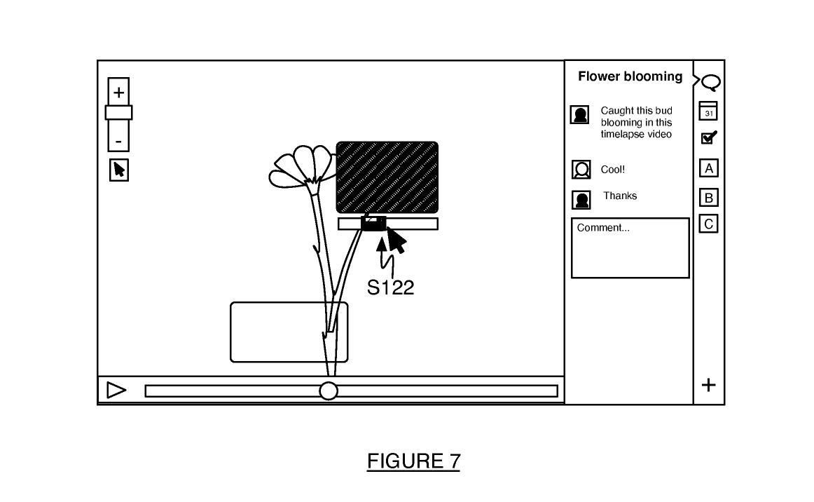

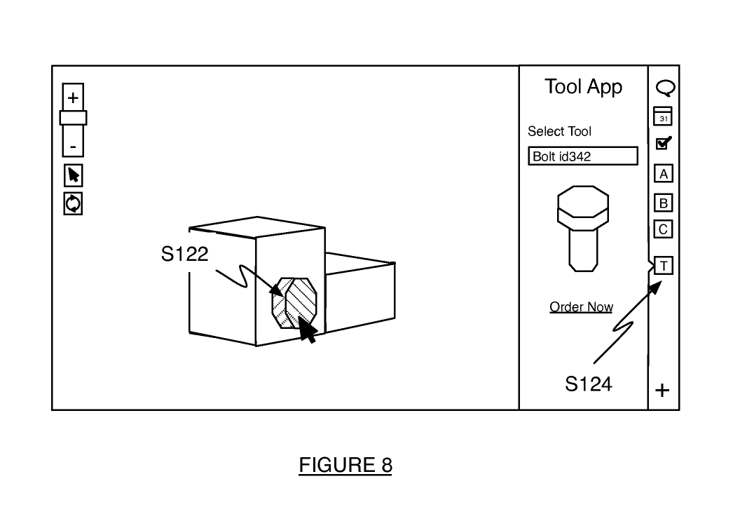

Step S122, which includes selecting the region of the media object, functions to determine at least one point in the presented media to associate with a media tag. A selected region is preferably a rectangular boxed region of an image but may be any other 2D or 3D geometric shape, including drawn region selection. As shown in FIG. 6, a user can select the region through a click and drag interaction. The selected region may alternatively be any suitable geometric shape, an arbitrary shape/form, a point, or any defined reference to at least one point of the image. A variety of selection tools could include a rectangle tool, oval tool, arbitrary polygon too, a free drawing tool, auto/magic selection tool, and/or any suitable selection tool. Machine Vision can additionally be employed to automatically isolate or determine a region around a selected object in an image, wherein the outline of the object is the region of the media tag. In alternative embodiments where the image is a 3D image, a video, or alternative media medium, the selected region may additionally define additional regions in a temporal, spatial, or alternative dimension. As shown in FIG. 7, a temporal selection of a video can be made in addition to a spatial one in a video media object. As shown in FIG. 8, a three-dimensional model can select volume region, in this case a three-dimensional part volume. The selected region may additionally be a plurality of regions such that content of an application instance is associated with each region in the plurality of regions. At a user application interface such as on a mobile device, or a browser, a selected region is preferably interpreted from user input. The user input can be a drawn shape/region, selected point, or other indication of the selected region. Selecting the region can include recording region selection with a resolution twice that of the image. User selections may be tracked with a spatial resolution greater than the resolution of an image such that sub-pixel accuracy can be achieved in defining a selected region. The method can additionally include enabling zooming the image to at least twice the resolution of the image when rendering or presenting the image. For example, a user drawing an arbitrary shape on a mobile device is preferably tracked on a Cartesian plane of at least twice the resolution of the image. More generally, the resolution of region tracking is recorded with a resolution equivalent to the effective image resolution at maximum zoom level. If an image is 1000×1000, and a user can zoom in such that the image is extrapolated to twice its normal resolution (i.e., an effective resolution of 2000×2000), then the region is tracked on a Cartesian plane of 2000×2000. When presenting the image, the image is preferably able to zoom to twice the normal resolution. The sub-pixel region recording functions to allow consistent positioning of a media tag indicator regardless of the zoom level or viewed effective resolution of the image. Media with a time dimension, where the media can be presented at a speed slower than normal speed, can similarly record the temporal region of a media tag with a temporal resolution greater than that of the media object. The selected region may alternatively be automatically selected through computer vision detection of objects or other suitable techniques. For example, color properties and other image characteristics may be used to select regions. The selected region may be described by region parameters such that the region can be accurately preserved across platforms displaying the image at different resolutions. For example, the selected region on any device and at any zoom level or viewing perspective preferably references substantially the same region of the image. Additionally or alternatively, the region of the image may be selected through a programmatic API call. The API call can similarly define the region of the image for selection by specifying points and/or shape properties. The API can preferably be used by third party applications or services to tag a region of the image. The third party applications can implement an interface similar to the one described above or use any suitable technique to select a region of the image through the API.

Step S124, which includes activating at least one application instance to be associated with the media tag, functions to obtain selection of an application to associate with the media tag. The method is preferably used to allow different applications to be used in tagging regions of a media object. In some variations, only a single application may be enabled, and thus that application is automatically selected. In other variations, activating an application instance can include obtaining user selection of an application. The method can additionally include obtaining user selection of two or more applications. Multiple application instances can be associated with a media tag, and content can be collected by each application to provide specialized interactions for the tagged region of the media object. A user can activate an application instance by selecting one of the applications displayed in a set of application options or by adding a new application. A default application can be initially selected, such as in the case if there is only one application option available.

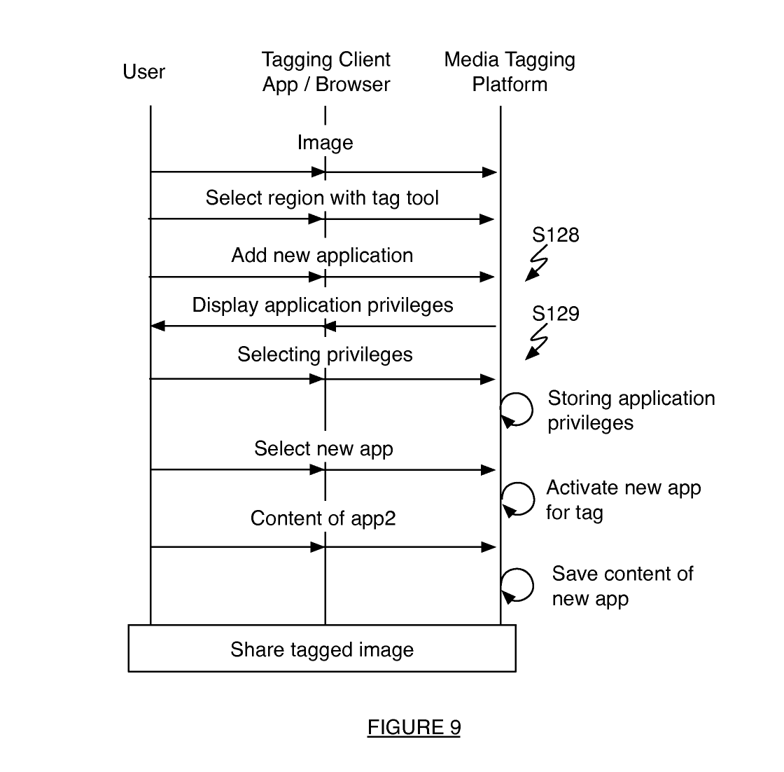

The method can additionally include adding an application S128, as shown in FIG. 9. An account user can add an application by selecting an application from a marketplace of available applications. This variation can enable a marketplace of applications to be provided where a user account can customize which applications are installed and/or available for use. Applications can be freely available or may require purchase for use. Alternatively, a manual installation mechanism can be enabled wherein an application is manually added to an account or media object. In one variation, third party applications could be added by adding application resources in an account configuration page. In another variation, applications run within an iframe and thus the URI of the application can be added to list of plug-ins. Third party applications can additionally include authenticating with an outside platform and granting privileges to the media tagging platform S129. When adding an application, the media tagging platform can set permissions of the application within the account. Alternatively, permissions may be set for an application within an individual image or a group of images. The permissions can define read and write privileges of the application in different scopes of a media tag. A basic set of permissions enables access to information of the associated media tag. A broader set of permissions can enable access to media tags and media data of the media object associated with the media tag. Yet additional permissions can define capabilities of an application to interact with images and media tags within the account.

The set of applications can include default applications and/or third party applications. Various types of applications can leverage the media tagging framework of the media tagging platform. Leveraging the media tagging platform, applications can enable unique interactions within a single media tag, across multiple media tags in a single image, across multiple media tags in multiple images of an account, across multiple media tags of multiple accounts, media tags generated in association with application-specific logic, media tags within a certain time window, and in other groupings of media tags. Some exemplary types of application types include social interaction applications (e.g., commenting, voting, polls, question and answer applications), outside service applications (e.g., applications that integrate information and/or functionality from an outside service), machine vision applications (e.g., automatically analyze image data to generate content), interface applications (e.g., home automation tools that leverage media tagging to enable a control interface), and other suitable types of applications. Some more specific applications can include commenting applications, question and answer applications, a scheduling/event/calendar application, machine vision based applications, search applications, voice recording applications, contacts applications, marketplace/checkout applications, affiliate/referral applications, database/data storage/record keeping applications, media tool applications, code reading applications (e.g., UPC, barcode, QR code reading), chat and social interaction applications, government documentation applications, genealogy documentation applications, home automation applications, internet enabled device applications, content navigation/exploration applications, and numerous other applications.

An exemplary commenting application, as shown in FIG. 6, can include a title field, a description field and then an array of comments. The title and description content is preferably defined when creating or editing the media tag such as by an administrator. The comment content can be generated when the tagged media is shared. Any suitable commenting features can be integrated into the application.

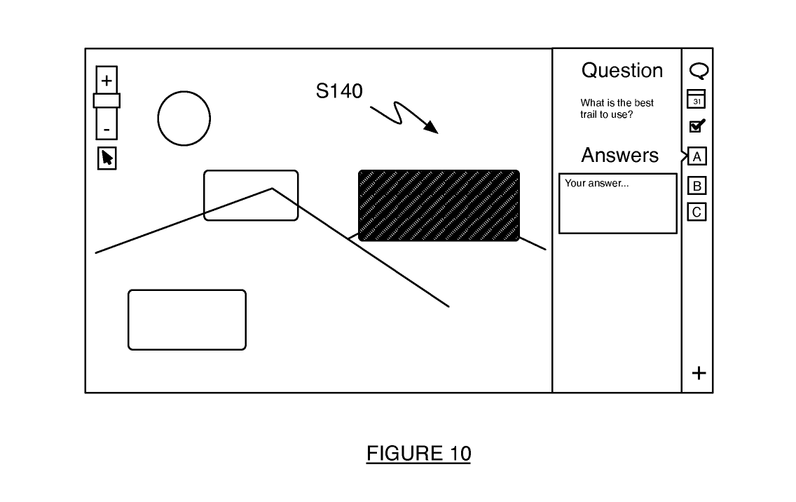

An exemplary question and answer application can function similar to the commenting application as shown in FIG. 10. A question field is preferably supplied when creating or editing the media tag. Answer content is collected from users when the tagged image is shared.

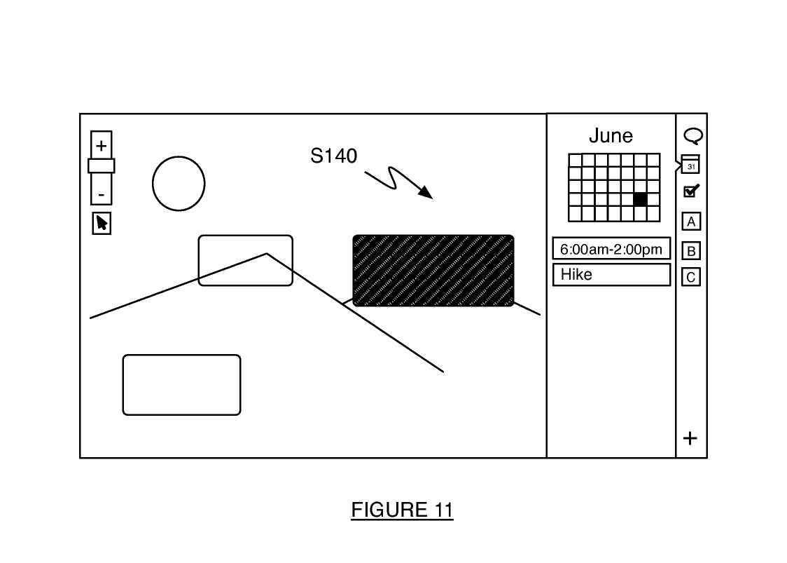

An exemplary scheduling application can include a data picker input and an event description field as shown in FIG. 11. Other optional content fields can include event location, event invitees, event notes, and other suitable properties of the event. The scheduling application can additionally synchronize created events with a calendar application. The media data of the media tag can be integrated with the events synchronized with the calendar application. For example, the media tag API can be used to add a link to the tagged region in the event item when displayed in the calendar application.

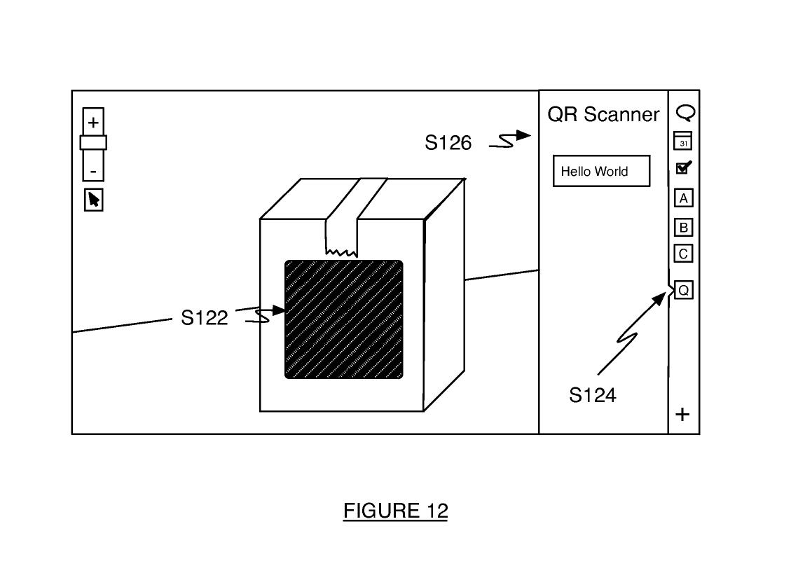

Machine-vision based applications can use a variety of approaches to interact with a media tag. In some exemplary applications, the sub-image region of the media tag is processed by the machine-vision application and a corresponding result is generated. For example, if the machine-vision based application is used in QR code recognition, content of the QR code can be retrieved as shown in FIG. 12. If the machine-vision based application is used in OCR, the identified text can be displayed.

Additionally, as described above, the method can include adding a new application to a marketplace of the media tagging platform. A developer account preferably adds an application. Once added, an instance of the application can be used with media tags if selected by a user. An application can be defined in various ways. An application, when activated, can receive any permitted metadata content relating to the media tag. The media tag information can include a unique identifier of the media tag, media data for the selected region of the media tag (e.g., the part of the image in the region of the media tag), region information (e.g., x-y positioning and dimensions), and/or other suitable information. If permissions do not limit information, the application can additionally receive information about the full media object (e.g., access image data of the full image), other media tags, other tagged images, other activated applications, and other suitable information outside of just the directly associated media tag. Such media tag information can be used by an application to provide relevant content interactions. In a first variation, an application is defined by a script file with application logic of the application. The script can follow a protocol or use a library for interacting with media tag information. The application can additionally include other application resources such as content editing resources (e.g., used when creating or editing an application instance), a public content interface resource (e.g., used when displaying the content to a user without editing capabilities), and other suitable resources. Such resources can be defined in terms of web application files (e.g., HTML, template files, CSS, and other suitable resources). In a second variation, a developer can implement the application on an application server externally hosted. The application can correspondingly be configured by supplying a URI to the media tagging platform that identifies where the application can be accessed. A protocol is used to deliver media tag information to the externally hosted application server. Content captured by the application can be stored and managed on the external application. Alternatively, a media tag application can be configured in any suitable manner.

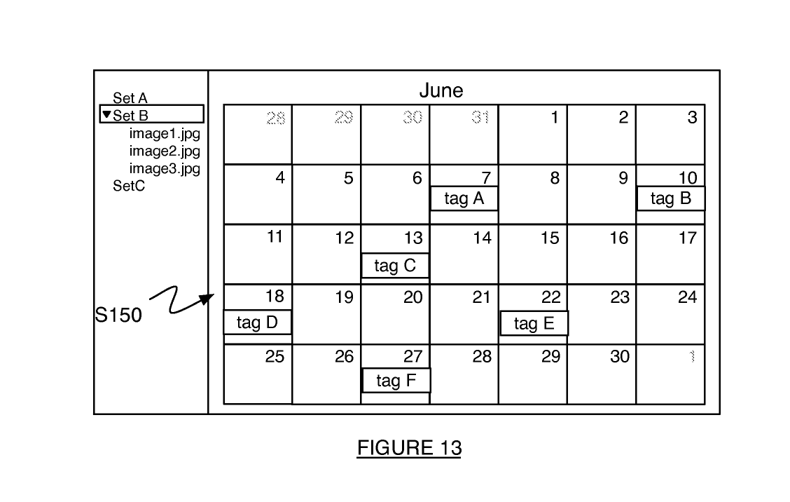

Step S126, which includes collecting content of the media tag with the selected region, functions to create a tag for a portion of the image. A media tag is preferably supplemental content for a region of an image or media file. The application instance preferably manages content of the media tag. Preferably, content is supplied and/or generated when creating or initially setting up a media tag. Alternatively, an application can be simply activated for a media tag, and the content is captured or generated by the application at a later point. For example, the application can be used to capture input after the tagged media object is shared with other users, such as in the case of a poll application, a comment application, or a voting application. In many cases, initial content is supplied when setting up an application instance, and additional content is collected through the application at a later time (e.g., when the image is shared with others). At a client application, a user can preferably create the content of a tag after or before selecting a region of the image. In other alternatives the media content may be automatically generated. Application instances of a media tag can include a variety of various mediums. In one variation, an application instance of a media tag can include text, an image, an audio recording, a multimedia file, or any suitable media file. In a second variation, a media tag can additionally or alternatively be an internet link (i.e., URI), application link, or a media tag link. The link will preferably direct a user to a webpage or outside application when viewing the media tag or when selecting the media tag. As an example, a media tag application link could link to other tagged images, thus allowing a user to navigate to different tagged images by clicking on a tag. In another variation, an application instance may be embedded in an interface displaying the tagged media object. The application instance is preferably a rendered and functional application interface displayed in the media tag, along side the media tag, or in any suitable location. The application instance may be configured to provide arbitrary functionality. Application instances may additionally be utilized to enable third party developers to integrate their own custom application functionality on top of the media tag functionality. An application instance may be selected from a plurality of different applications. The media content may additionally include multiple application instances for a single tag. Each instance can include different content. For example, a user may add an event application instance and a todo application instance as media content of the tag. Media tags with application instance content or application parameter content may be used to aggregate content from the various media tags. For example, a user can preferably view all application content created across a plurality of media tags (e.g., events from a calendar application) for all images or a set of images. A dedicated interface may be created for viewing media tag content, such as a calendar application as shown in FIG. 13, todo-list application, or any suitable application that may benefit from aggregate application instance media tag data. Such media content aggregation functions to enable the creation of a unified user interface through the media tags. The content of a media tag may additionally be any suitable combination of the above content types or additional alternative content.

Step S130, which includes tiling the media image S130, functions to divide the image into sub-images in preparation for serving tiles of the image. The tiling of images preferably enables the tagged images to be efficiently and scalably used in a variety of use-cases. As one exemplary benefit, tiling can preferably enable tagging images of arbitrary resolution. Since tiling will enable more efficient serving of images, very high-resolution images may be used, such as 10 MB images, gigapixel images, or larger images. Such large images can be efficiently served and rendered in Step S140 by tiling the image to smaller portions of the image. Sub-pixel recording of media tag regions can enable the region to consistently map to the same region of large images. A wide variety of devices with differing screen sizes and data limits may additionally utilize the image tagging system as a result of tiling the image. As another exemplary benefit, tiling preferably enables an API to work in combination with the media cloud service to provide efficient and optimized access to images and tagged regions of images. For example, an application using the API may want to display just the tagged regions. By tiling the image, just the region of interest for an access tag can be accessed.

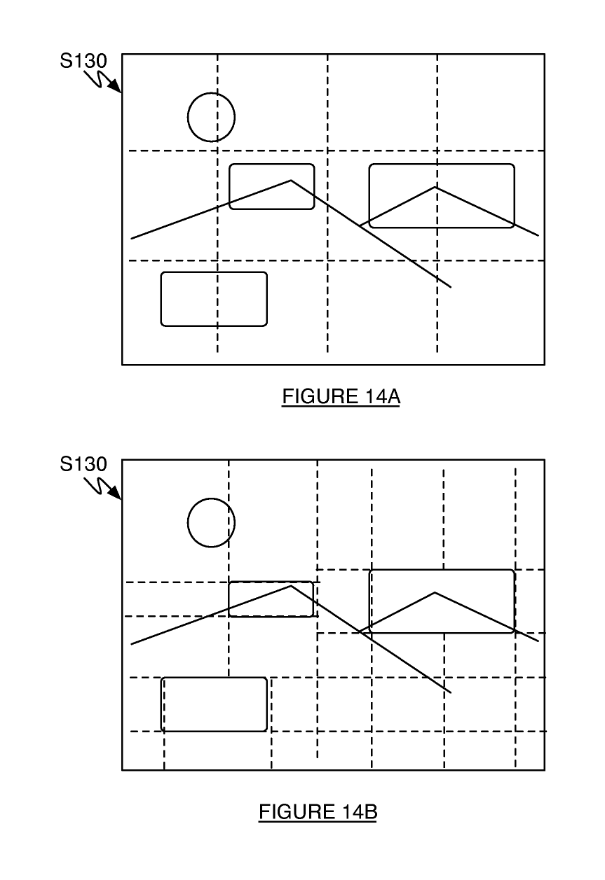

Tiling the image preferably divides an image into a plurality of tiles or images as shown in FIG. 14A. The combination of the plurality of tiles can preferably be used in combination to form at least one continuous region of the image, where the continuous region is typically a region greater than a region of an individual tile. The tiles are preferably generated for at least one zoom level, but may be generated for a plurality of zoom levels. The tiles preferably use an image resolution suitable for the desired zoom level. In one variation, the tiles are arranged such that the tiles have a set alignment to a region of a media tag. For example, a tile grid may be set so that no region of a media tag is divided between two tiles. The tiles are preferably uniform in shape and size, but may alternatively be any suitable collection of individual images. Tiles produced by the image tiling system may be customized to fit a device display size and resolution. For example, the size of a tile generated for a client application viewed on a mobile phone may be different from the size of a tile generated for viewing on a desktop browser. Images are preferably divided into tiles on the media cloud service. The media cloud service preferably tiles an image when a request for an image or portion of the image is received. However, the images may be tiled at an image tiling system on a client device such as a mobile device or in a browser. The image is preferably tiled when serving the image and/or uploading the image, but the image may alternatively be proactively tiled. The tiles are preferably cached to avoid duplicate processing. Any suitable tiling procedure may alternatively be used. In one variation, tiling is preferably augmented to tile regions of media tags into a single sub-image as shown in FIG. 14B. When dividing the image, the media tag regions are defined as tiles. Regions not included in a media tag will be tiled in any suitable manner. Media tiles with overlapping regions can be tiled such that the overlap is redundant between the tiled sub-images of the media tags. Overlaps could alternatively be handled in any suitable manner.

The method may additionally include storing the image and the media tag for the selected region, which functions to create the resources necessary to deliver the tagged image. Preferably the image, the selected region, and the media tag content are received at the media cloud service at substantially the same time and then stored. In some variations, the image may be pre-tiled in preparation for rendering the image. The images, the parameters embodying the media tag region(s), and the content of the media tag(s) may be stored in any suitable fashion. In other variations, content of an application instance is stored by external application resources of a developer. The media tagging platform, however, preferably stores at least the metadata to retrieve such content from external resources. For example, an API resource for a media tag can include a media tag identifier and list of identifiers of active application instances of the media tag. During subsequent attempts to access content, the identifier of an active application can be used to transmit the media tag identifier to the corresponding external resource. A response generated by an external application server can then provide the content of the media tag for that application instance.

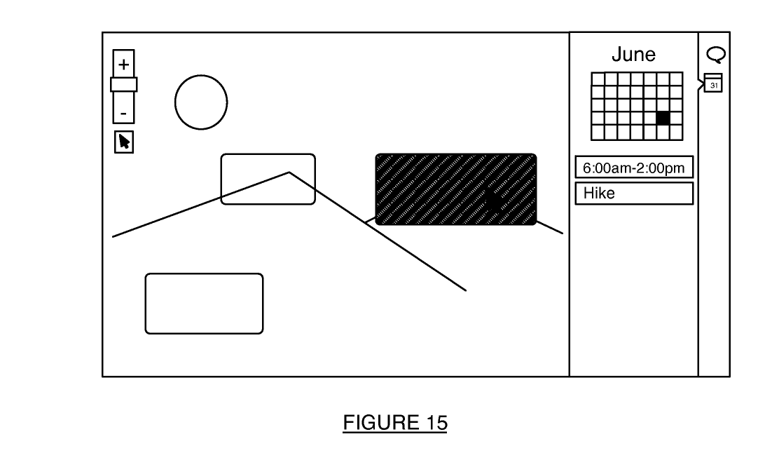

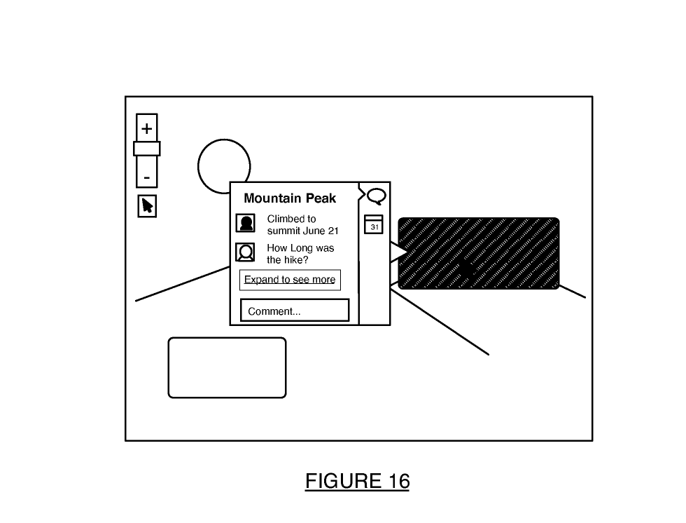

Step S140, which includes rendering the media object with the media tag, functions to deliver the image with the media tag. Rendering the image preferably includes delivering the required components to display the image with the media tag. Rendering may additionally include displaying and controlling display logic of the media tag. A rendered image with a media tag preferably enables highlighting/indicating the selected region of a tag, selecting of the media tag, and displaying or activating the content of the media tag. The media tags are preferably visually indicated in their associated region. User selection or activation of the region preferably triggers displaying tag content and/or activating an event for the content of the media tag. The media content (i.e., content of active application instances) may be displayed in a sidebar as shown in FIG. 15, in a popover as shown in FIG. 16, or in any suitable configuration. The rendered image interface may additionally enable zooming, panning, adding tags, editing tags, and removing tags. Additionally or alternatively, media tags may be rendered in a customized application interface. Preferably an application will specify a media tag widget interface and a full application interface. The media tag widget preferably facilitates adding application instance data when interacting with an image interface.

A full application interface preferably leverages the aggregate view of application instances. A user may have multiple photosets, each with a plurality of images. The media tag organization may be used in organizing the content of the full application interface. As an example, a calendar application may allow events to be viewed according to their image set and individual image organization as shown in FIG. 13. The tagged image may be delivered as a data package specifying the image, media tag region, and the content of the tag. Additionally, a viewing widget may additionally be delivered along with any tagged image components. The viewing widget preferably facilitates generating a user interface to appropriately display the tagged image. In one variation, an application will preferably have a viewing widget previously installed or incorporated and will know how to display the tagged image from the basic tagged image components. Rendering the image with the media tag may alternatively render the content of the tagged image into a data response suitable for an API request. For example, the media cloud service may generate a JSON data object that includes the parameters specifying an image URL link, a media tag region, and the media content. An API or a user application interface may alternatively request only a portion of a tagged image. For example, if an application desired to show a close up image for all the tags in an image, the application could preferably use the API to request an image for just the media tag region of each tag. Rendering of the tagged image may alternatively generate any suitable representation of the tagged image.

Additionally, the method of the preferred embodiment may include at least two devices collaboratively collecting an image S110, assigning at least one media tag to a region of an image S120 that includes selecting the region of the image S122 and collecting content of the media tag with the selected region S124, which functions to allow multiple users to interact with media tags in real-time. A real-time communication link is preferably established between the at least two devices through the media cloud service. Actions from one device are preferably reflected in the user interface of the at least second device, and users are able to collaboratively interact with image media tag content. For example, a first user may take a picture; a second user seeing the picture taken by the first user may assign a media tag to a particular region; and the first user can add more media tag content or otherwise modify the media tag. Users may have different privileges in terms of actions that may be performed or content that may be viewed. The devices may additionally cooperate in any suitable aspects.

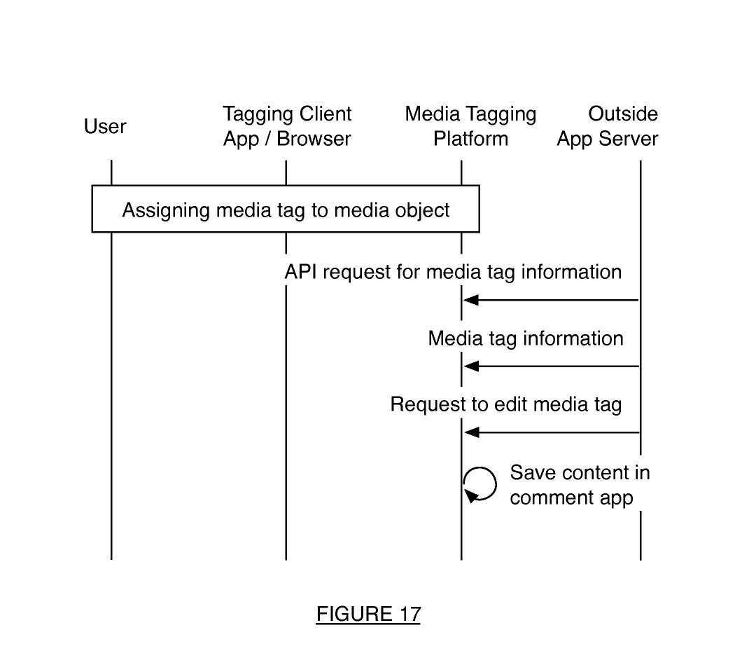

The method can additionally include creating API resources for media tags as shown in FIG. 17. Media tag API resources are preferably programmatically accessible mechanisms that outside developers can use to asynchronously interact with media tags. The API resources are preferably part of the media tag API described above. The media tag API is preferably used by outside applications to integrate media tags and/or media tagged images into outside application functionality. The media tag API can be used to supply or supplement content of outside applications with media tags or alternatively, outside applications can generate images and media tags within the media tagging platform on behalf of an account. In addition to creating API resources and providing API access to those resources, the method can include augmenting a media tag resource of a media object. Augmenting can include creating a media tag, deleting a media tag, removing an association with an application (i.e., deleting application instance content for the media tag), modifying contents of an application instance of the media tag, modifying properties of the media tag (e.g., moving or changing the region of the media tag), or making any suitable change. Similarly, providing a media tag API can additionally or alternatively include accessing media tag data. A third party application can be given permission for API access to information, which can be used in outside applications.

As an example of using RESTful media tag API, an application could access a list of users that have used the application by submitting a GET request to the media tag API resource of “/users/”. The outside application preferably supplies authentication information to indicate the developer account making the request. A GET request to the media tag API resource of “/users/user123/” can provide user information such as provided username, application permissions allowed by the user, and other suitable user information. A GET request to “/users/user123/tags/” can return a list of all tags that use the tag application of the developer account. The tags can include tag identifiers, image identifiers, the region, and optionally other tag content information. In some variations, multiple tag applications can be provided by a single developer account; alternative resource architecture can be used to distinguish between the tag applications. Finally a GET request to “/users/user123/tags/tagID456/” can be used to access information about an individual tag. Furthermore the media tag API can provide interfaces to modify the resources. For example, posting to “/users/user123/tags/tagID456/” can enable content or various properties to be altered. Some media tag API interactions can be limited or regulated according to application permissions. Alternatively, any suitable API model can be used to access tag resources and information.

An alternative embodiment preferably implements the above methods in a computer-readable medium storing computer-readable instructions. The instructions are preferably executed by computer-executable components preferably integrated with a media tagging platform. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method comprising:
obtaining an image and displaying the image within an image tagging interface;
in the tagging interface, assigning at least one media tag to a region of an image, wherein assigning a media tag comprises selecting the region of the image, activating at least one application instance to associate with the media tag, and collecting content of the at least one application instance within the image tagging interface;
tiling the image into a plurality of sub-images; and
rendering the tiled image with an indicator in the region of the at least one media tag, and on selection of a media tag activating at least the one application instance with the collected content of the application instance.

2. The method of claim 1, wherein selecting the region of the image comprises recording region selection with a resolution twice that of the image; and wherein rendering the image with the media tag enables zooming image to at least twice the resolution of the image.

3. The method of claim 1, wherein for each media tag, the region of the media tag is tiled into a single sub-image.

4. The method of claim 1, wherein activating at least one application instance to associate with the media tag comprises activating a user interface of the application instance with user input elements to collect content.

5. The method of claim 1, wherein two different application instances are activated for the media tag; and wherein on selection of the media tag in the rendered tiled image enables selectively activating an interface of least one application instance with the collected content of the selected application instance.

6. The method of claim 5, wherein activating at least one application instance comprises receiving user selection of an application instance from a set of applications comprising a comment application, a question and answer application, a scheduling application, and machine-vision based application.

7. The method of claim 1, further comprising creating API resources for media tags and providing access to media tag API resources by activated applications of a media tag.

8. A method for tagging an image comprising:
obtaining an image and displaying the image within an image tagging interface;
in the image tagging interface, obtaining user selection of an image tag in a region of the image;
obtaining selection of a first application;
displaying a content collection interface of a first instance of the first application assigned to the image tag;
rendering the tagged image with an indicator in the region of the image tag; and
on selection of the first tag indicator in the rendered tagged image, activating the first application with the collected content.

9. The method of claim 8, wherein selection of the first application is selected from a set of available tag applications.

10. The method of claim 9, wherein the set of available tag applications comprises a comment application, a question and answer application, an event application, and machine-vision based application.

11. The method of claim 9, further comprising adding a new application to the set of available tag applications.

12. The method of claim 11, further comprising setting image permissions of the new application within a user account.

13. The method of claim 12, wherein setting image permissions comprises limiting image data access to that of the region of assigned image tag.

14. The method of claim 8, further comprising obtaining selection of a second application; displaying a content collection interface of a second instance of the second application; and on selection of the first tag indicator in the rendered tagged image, activating the second tag application with the collected content of the second application.

15. The method of claim 8, further comprising creating API resources for image tags and providing access to image tag API resources by activated applications of a media tag.

16. A method for tagging media comprising:
obtaining a media object and presenting the media within a media tagging interface;
in the media tagging interface, obtaining selection of a region of the presented media to create a first media tag;
obtaining user selection of at least a first application instance to assign to the first media tag;
collecting content of the first application instance;
rendering the tagged media with an indicator in the region of the first media tag; and
on selection of the indicator in the rendered tagged media, activating a user interface of the first application instance with the collected content.

17. The method of claim 16, further comprising obtaining selection of a second application; displaying a content collection interface of a second instance of the second application; and on selection of the first tag indicator in the rendered tagged image, activating the second tag application with the collected content of the second application.

18. The method of claim 17, further comprising adding a new application to the set of available tag applications.

19. The method of claim 18, further comprising setting image permissions of the new application within a user account.

20. The method of claim 8, further comprising creating API resources for media tags and providing access to image tag API resources by activated applications of a media tag and according to permissions of an application.

21. The method of claim 18, wherein the media object is an image.

22. The method of claim 18, wherein the media object is a video.

23. The method of claim 18, wherein the media object is three-dimensional model.

24. The method of claim 16, wherein rendering the tagged media is rendered within an embedded media element.
